(19) United States
(12) Patent Application Publication
(10) Pub. No.: US 2026/0044490 A1
(43) Pub. Date: Feb. 12, 2026

(54) APPARATUS AND METHOD FOR GENERATING AN OUTPUT USING AN AI-PII MODEL

(71) Applicant: DevReady Holdings, LLC, Englewood, CO (US)

(72) Inventor: Scott Patrick Cunningham, Corpus Christi, TX (US)

(73) Assignee: DevReady Holdings, LLC, Englewood, CO (US)

(21) Appl. No.: 19/293,100

(22) Filed: Aug. 7, 2025

Related U.S. Application Data
(60) Provisional application No. 63/680,396, filed on Aug. 7, 2024.

(51) Int. Cl. G06F 16/23; G06F 16/21; G06F 16/25; G06N 20/00

(52) U.S. Cl. CPC G06F 16/2365; G06F 16/212; G06F 16/258; G06N 20/00

(57) ABSTRACT

Apparatus and method for generating an output using an AI-PII model. The apparatus includes at least a processor and memory communicatively connected to the at least a processor. The memory instructs the processor receive personally identifiable information (PII) data, receive one or more model constraints, map, using an AI-PII model, the PII data to at least a data schema as a function of the one or more model constraints by identifying at least a PII datum of the PII data, categorizing the at least a PII datum to one or more categories of a plurality of categories, and mapping the PII data to the at least a data schema, modify the data schema based on a refinement datum, wherein the refinement datum is generated based on a temporal datum of the one or more model constraints, and generate an output as a function of the refinement datum and data schema.

### CROSS-REFERENCE TO RELATED APPLICATIONS

This application claims the benefit of priority of U.S. Provisional Patent Application Ser. No. 63/680,396, filed on Aug. 7, 2024, and titled “W5 GUARD-R (A.I.) L FOR AI CONSISTENCY IN PII DATA MAPPING,” which is incorporated by reference herein in its entirety.

### FIELD OF THE INVENTION

The present invention generally relates to the field of machine learning. In particular, the present invention is directed to an apparatus and a method for generating an output using an AI-PII model.

### BACKGROUND

AI systems used for mapping Personally Identifiable Information (PII) into structured formats often produce inconsistent results due to variability in decision-making and lack of standardized rules. This inconsistency presents significant challenges for maintaining data integrity, ensuring regulatory compliance, and supporting scalable data management.

### SUMMARY OF THE DISCLOSURE

In an aspect, an apparatus for generating an output using an AI-PII model includes at least a processor and a memory communicatively connected to the at least a processor. The memory contains instructions configuring the processor to receive personally identifiable information (PII) data, receive one or more model constraints, map, using an AI-PII model, the PII data to at least a data schema as a function of the one or more model constraints by identifying, using the AI-PII model, at least a PII datum of the PII data, categorizing, using the AI-PII model, the at least a PII datum to one or more categories of a plurality of categories, and mapping, using the AI-PII model the PII data to the at least a data schema, modify, using the at least a processor, the mapped data schema based on a refinement datum, wherein the refinement datum is generated based on a temporal datum of the one or more model constraints, and generate, using the AI-PII model, an output as a function of the refinement datum and the data schema.

In another aspect, a method for generating an output using an AI-PII model includes receiving, using at least a process, personally identifiable information (PII) data, receiving, using the at least a processor, one or more model constraints, mapping, using an AI-PII model, the PII data to at least a data schema as a function of the one or more model constraints by identifying, using the AI-PII model, at least a PII datum of the PII data, categorizing, using the AI-PII model, the at least a PII datum to one or more categories of a plurality of categories, and mapping, using the AI-PII model the PII data to the at least a data schema, modifying, using the at least a processor, the data schema based on a refinement datum, wherein the refinement datum is generated based on a temporal datum of the one or more model constraints, and generating, using the AI-PII model, an output as a function of the refinement datum and the data schema.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an apparatus for generating an output using an AI-PII model;

FIG. 2 is a block diagram of an exemplary machine-learning process;

FIG. 3 is a diagram of an exemplary embodiment of a neural network;

FIG. 4 is a diagram of an exemplary embodiment of a node of a neural network;

FIG. 5 is a diagram of an exemplary embodiment of a cryptographic accumulator;

FIG. 6 is a block diagram of an exemplary method for generating an output using an AI-PII model; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

The present invention introduces a proprietary methodology termed “Guardrails for AI Consistency in PII Data Mapping”-W5 Guard-R(a.i.)|™, which ensures that AI consistently produces reliable and accurate results when creating data dictionaries for PII. The invention involves embedding a set of coded rules, referred to as “guardrails,” into the AI's operational framework, akin to parenting an AI teenager by providing it with clear and strict guidelines to follow.

Guardrails Implementation—The core of the invention is the integration of “guardrails” within the AI system. These guardrails are a set of predefined rules and algorithms coded into the AI's decision-making processes. They guide the AI in recognizing, categorizing, and mapping PII data into a structured and consistent format.

Rule-Based Coding-Our methodology involves the meticulous coding of rules that the AI must adhere to. These rules are designed based on regulatory standards, data management best practices, and specific business requirements. By coding these rules, we create a structured environment where the AI operates within well-defined boundaries, minimizing the risk of inconsistent results.

Consistent Data Schema—The guardrails ensure that all PII data is mapped into a consistent data schema. This schema is predefined and standardized, ensuring uniformity in data representation regardless of the source or nature of the PII data. The AI, guided by the guardrails, maps the data into this schema with high accuracy and consistency.

Continuous Monitoring and Adjustment—The system includes continuous monitoring mechanisms to ensure the AI adheres to the guardrails. Any deviations or inconsistencies are promptly identified and corrected through automated feedback loops. This dynamic adjustment capability ensures the AI evolves and improves over time, maintaining a high level of consistency.

Analogy to Parenting—The guardrails can be likened to parenting an AI teenager. Just as parents provide rules and guidelines to help their teenagers navigate complex decisions and behaviors, our methodology provides the AI with a structured set of rules to follow. This guidance ensures the AI behaves predictably and consistently, producing reliable outcomes).

The present invention, “W5 Guard-R(a.i.)|™,” pertains to the field of artificial intelligence (AI) and data management, specifically focusing on the creation of consistent data dictionaries for Personally Identifiable Information (PII) using AI. This invention addresses the challenge of AI producing inconsistent results when mapping PII data into structured schemas, a significant issue given the increasing reliance on AI for data management and compliance tasks.

Traditional AI models often return inconsistent results due to their inherent variability and lack of structured rules, particularly when handling complex PII data across diverse datasets. This inconsistency poses risks to compliance, data integrity, and operational efficiency. The invention introduces a proprietary methodology termed “Guardrails for AI Consistency in PII Data Mapping”-W5 Guard-R(a.i.)|™, which ensures that AI consistently produces reliable and accurate results when creating data dictionaries for PII.

The core of the invention is the integration of “guardrails” within the AI system. These guardrails are a set of predefined rules and algorithms embedded into the AI's decision-making processes, guiding the AI in recognizing, categorizing, and mapping PII data into a structured and consistent format. The methodology involves meticulous coding of these rules based on regulatory standards, data management best practices, and specific business requirements, creating a structured environment where the AI operates within well-defined boundaries.

The guardrails ensure that all PII data is mapped into a consistent data schema, which is predefined and standardized, ensuring uniformity in data representation regardless of the data source. Continuous monitoring mechanisms are included to ensure adherence to the guardrails, with automated feedback loops to identify and correct deviations, thus enabling dynamic adjustment and continuous improvement over time.

The invention also draws an analogy to parenting, where the guardrails provide structured rules and guidelines for the AI to follow, ensuring predictable and consistent behavior, and producing reliable outcomes.

Applications and advantages of this invention include ensuring regulatory compliance by maintaining consistent and accurate PII data mappings, enhancing data integrity, streamlining data management processes to reduce manual intervention, and supporting scalability to handle increasing data volumes and complexity without compromising consistency.

At a high level, aspects of the present disclosure are directed to apparatus and methods for generating an output using an AI-PII model. The apparatus includes at least a computing device comprised of a processor and a memory communicatively connected to the processor. The memory instructs the processor to receive personally identifiable information (PII) data. The processor receives one or more model constraints. The processor maps, using an AI-PII model, the PII data to at least a data schema as a function of the one or more model constraints by identifying, using the AI-PII model, at least a PII datum of the PII data, categorizing, using the AI-PII model, the at least a PII datum to one or more categories of a plurality of categories, and mapping, using the AI-PII model the PII data to the at least a data schema. Additionally, the processor modifies the data schema based on a refinement datum, wherein the refinement datum is generated based on a temporal datum of the one or more model constraints. The processor generates, using the AI-PII model, an output as a function of the refinement datum and the data schema.

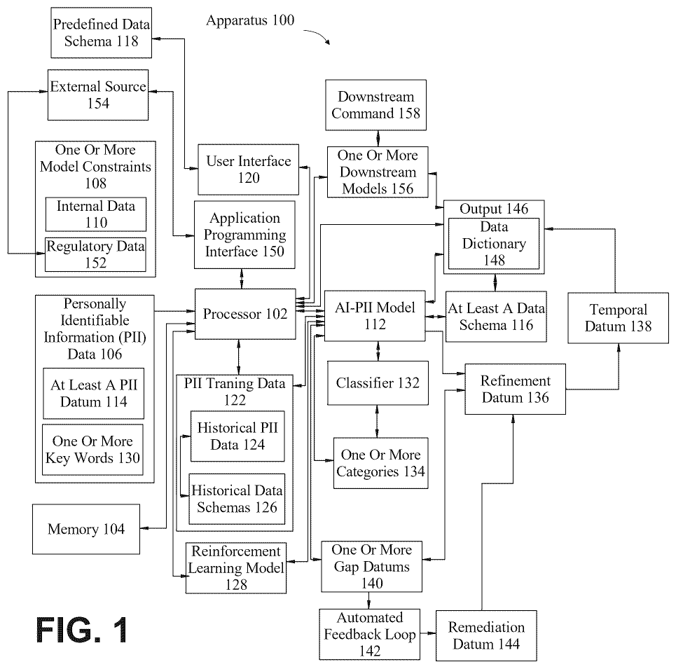

Referring now to FIG. 1, an exemplary embodiment of apparatus 100 for generating an output using an AI-PII model is illustrated. Apparatus 100 may include a processor 102 communicatively connected to a memory 104. As used in this disclosure, “communicatively connected” means connected by way of a connection, attachment, or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 104 may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein processor 102 may access the information from primary memory.

Still referring to FIG. 1, apparatus 100 may include a database. The database may include a remote database. The database may be implemented, without limitation, as a relational database, a key-value retrieval database such as a NOSQL database, or any other format or structure for use as database that a person skilled in the art would recognize as suitable upon review of the entirety of this disclosure. The database may alternatively or additionally be implemented using a distributed data storage protocol and/or data structure, such as a distributed hash table or the like. The database may include a plurality of data entries and/or records as described above. Data entries in database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in database may store, retrieve, organize, and/or reflect data and/or records.

With continued reference to FIG. 1, apparatus 100 may include and/or be communicatively connected to a server, such as but not limited to, a remote server, a cloud server, a network server and the like. In one or more embodiments, the computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by the apparatus computing device. In one or more embodiments, computing device may transmit processes to server wherein computing device may conserve power or energy.

Further referring to FIG. 1, apparatus 100 may include any “computing device” as described in this disclosure, including without limitation a microcontroller, microprocessor, digital signal processor (DSP) and/or system on a chip (SoC) as described in this disclosure. Apparatus 100 may include, be included in, and/or communicate with a mobile device such as a mobile telephone or smartphone. Apparatus 100 may include a single computing device operating independently, or may include two or more computing devices operating in concert, in parallel, sequentially or the like; two or more computing devices may be included together in a single computing device or in two or more computing devices. Apparatus 100 may interface or communicate with one or more additional devices as described below in further detail via a network interface device. Network interface device may be utilized for connecting processor 102 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 102 may include but is not limited to, for example, a computing device or cluster of computing devices in a first location and a second computing device or cluster of computing devices in a second location. Apparatus 100 may include one or more computing devices dedicated to data storage, security, distribution of traffic for load balancing, and the like. Apparatus 100 may distribute one or more computing tasks as described below across a plurality of computing devices of computing device, which may operate in parallel, in series, redundantly, or in any other manner used for distribution of tasks or memory between computing devices. Apparatus 100 may be implemented, as a non-limiting example, using a “shared nothing” architecture.

With continued reference to FIG. 1, processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 102 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, processor 102 is configured to receive personally identifiable information (PII) data 106. As used in this disclosure, “personally identifiable information (PII) data” is data that can be used to identify, contact, or locate a specific individual. PII data 106 includes, but is not limited to, names, addresses, phone numbers, email addresses, social security numbers, dates of birth, government-issued identification numbers, biometric records, financial account numbers, and any other information that is linked or linkable to an entity. In an embodiment, the entity may include a natural person, an organization, and the like. In an embodiment, processor 102 is configured to receive personally identifiable information (PII) data via secure enterprise application programming interfaces (APIs). For example, without limitation, a company may configure an API integration with its internal customer relationship management (CRM) system, such as Salesforce, to stream contact information including names, email addresses, and phone numbers directly into the processor 102. In a non-limiting example, human resources data may be transmitted through API calls from a platform like Workday, where employee IDs, birthdates, and employment records are continuously updated and made available to processor 102. In a non-limiting example, processor 102 may also receive PII data 106 through a user interface 120 (UI) provided by a company. For example, without limitation, a secure web portal may allow data governance teams or privacy officers to upload spreadsheets or CSV files containing structured PII datasets. These interfaces may be built using technologies such as React or Angular and hosted within a secure intranet or cloud environment using platforms such as AWS Amplify or Azure App Service. Without limitation, processor 102 may further ingest PII data 106 through automated batch upload pipelines or scheduled ETL (Extract, Transform, Load) workflows. In a non-limiting example, a batch upload job may run nightly using Apache NiFi or Talend to extract customer records from a data warehouse like Amazon Redshift or Google BigQuery, transform those records into a consistent schema, and load them into the AI system for processing. In a non-limiting example, processor 102 may also be configured to ingest PII data 106 in real-time using event-driven architecture. For example, without limitation, the processor 102 may subscribe to a Kafka topic receiving event logs from customer support platforms like Zendesk, or may listen to a stream of transaction events through AWS Kinesis. This configuration allows the AI model to operate on fresh data with minimal latency, improving responsiveness and scalability. In an embodiment, once the PII data 106 is received, processor 102 may execute preprocessing operations to prepare the data for AI-based analysis. For example, without limitation, the processor 102 may normalize inconsistent date formats (e.g., converting “Dec. 31, 2025” and “31-Dec-25” into ISO 8601 format) using Python-based transformation scripts executed within an Apache Spark job. In a non-limiting example, the processor 102 may invoke a data quality framework such as Great Expectations to validate email address formats, ensure required fields are populated, and flag records with missing or malformed values. Without limitation, processor 102 may perform secure processing of PII by applying tokenization or encryption to sensitive fields prior to storage or AI model ingestion. For example, in an embodiment, names and social security numbers may be tokenized using deterministic hashing functions, or encrypted using symmetric key encryption with key management handled by systems such as HashiCorp Vault or AWS Key Management Service (KMS). These operations ensure compliance with privacy regulations such as GDPR or HIPAA and help mitigate risk in the event of a data breach.

Still referring to FIG. 1, processor 102 is configured to receive one or more model constraints 108. As used in this disclosure, “model constraints” are predefined limitations, rules, or conditions that govern the behavior and outputs of the AI-PII model 112. Model constraints 108 include, but are not limited to, regulatory standards, data handling policies, schema formatting rules, organizational business logic, and data quality requirements. These constraints guide the AI-PII model 112 in processing, categorizing, and mapping PII data 106 to ensure consistency, compliance, and alignment with intended use cases. In an embodiment, processor 102 is configured to receive one or more model constraints 108 that govern how the AI-PII model 112 processes, maps, and outputs PII data 106. Model constraints 108 may include regulatory rules, business policies, data formatting requirements, and industry best practices. These constraints guide the AI system to ensure compliance, consistency, and accuracy in data handling. In a non-limiting example, model constraints 108 may be received through external regulatory data 152 feeds using secure APIs. For example, without limitation, processor 102 may call an API from a regulatory data 152 provider such as OneTrust, TrustArc, or a government open data source (e.g., GDPR schema references published by the European Data Protection Board). These APIs may return structured data formats (such as JSON or XML) containing updated regulatory parameters, which are then parsed and integrated into the model's rule engine. For example, without limitation, processor 102 may also retrieve model constraints 108 from a company's internal compliance management system, such as ServiceNow GRC (Governance, Risk, and Compliance) or LogicGate. In this embodiment, the system stores custom business logic, such as data retention limits or approved data categories, which are queried and incorporated into the model to restrict or direct PII mapping decisions. In a non-limiting example, constraints may be entered manually using a graphical user interface (GUI). For example, a data governance officer may use a web-based admin portal, built using frameworks like React or Vue.js, to define allowable PII categories 134, mandatory field mappings, or acceptable confidence thresholds. These inputs are then serialized and stored in configuration files or policy databases accessible to processor 102. Without limitation, processor 102 may also receive model constraints 108 stored in configuration files or policy documents located in version-controlled repositories such as GitHub or GitLab. In this embodiment, the processor 102 may pull the latest configuration at runtime using Git APIs or CI/CD integration tools like Jenkins, ensuring that constraint logic is versioned and traceable. In an embodiment, model constraints 108 may also be derived from natural language documents processed through document parsing or semantic extraction engines. For example, without limitation, processor 102 may use an NLP model to extract policy rules from internal privacy policies or legal contracts stored in systems like Microsoft SharePoint or Google Drive, translating them into structured guardrail conditions for the AI model. In a non-limiting example, processor 102 may receive time-sensitive constraint updates by listening to change events or triggers from a cloud service, such as AWS EventBridge or Azure Event Grid. This allows dynamic injection of updated constraints, such as emergency regulatory changes or new business rules, directly into the operational model in real time.

With continued reference to FIG. 1, the one or more model constraints 108 may include internal data 110, wherein the at least a processor 102 is further configured to receive the internal data 110. As used in this disclosure, “internal data” is data originating from within an entity's own systems, policies, or operational records. In a non-limiting example, the company may include a financial services company, wherein the financial services company may have a system labeling an internal data field as “client_number,” another labeling it as “customer_ID,” and yet another as “account_holder_code,” all referring to the same type of PII. This inconsistent mapping of similar internal data fields across platforms can lead to fragmented compliance reporting, duplicated records, and increased risk of data privacy violations, especially when AI systems attempt to process and categorize the data without a standardized reference framework. In an embodiment, internal data may include internal compliance protocols, custom data handling rules, proprietary classification schemes, schema mapping rules, or historical decision logs related to PII processing. In a non-limiting example, processor 102 may receive internal data 110 from enterprise knowledge bases or internal data 110 governance repositories. For example, without limitation, organizations may store data mapping policies, role-based access rules, or internal classification taxonomies in structured databases such as PostgreSQL or MongoDB, which may be accessed through RESTful APIs or direct query interfaces. For example, without limitation, processor 102 may retrieve internal data 110 from document management systems such as Microsoft SharePoint, Atlassian Confluence, or Google Workspace. In this embodiment, natural language processing (NLP) models may be applied to extract rule-based language or constraints from policy documents, standard operating procedures (SOPs), or internal audit reports. The extracted information may then be structured and passed to the AI-PII model 112 as internal constraints. In an embodiment, processor 102 may also receive internal data 110 in the form of user-defined configurations input through administrative user interfaces 120. For example, without limitation, a privacy officer may enter internal retention rules or field priority mappings through a dashboard built with technologies like React and backed by a NoSQL data store such as Firebase. These inputs may be serialized into JSON or YAML format and loaded into memory for immediate use by the processor 102. Without limitation, processor 102 may receive internal data 110 in the form of historical model behavior logs, including previously accepted or rejected schema mappings, which are stored in cloud storage systems such as AWS S3, Azure Blob Storage, or on-premises data lakes. In a non-limiting example, processor 102 may apply pattern recognition or statistical analysis techniques to infer constraints from trends in past decisions, supporting the dynamic tuning of the AI model over time. In a non-limiting example, processor 102 may be integrated with internal workflow or GRC (Governance, Risk, and Compliance) platforms such as ServiceNow, RSA Archer, or MetricStream, which track internal control requirements and data risk assessments. The processor 102 may poll these systems using secure API calls to retrieve the most current internal rules, which are then used to update the model constraints 108 applied during PII data 106 processing.

Still referring to FIG. 1, processor 102 is configured to map, using an AI-PII model 112, the PII data 106 to at least a data schema 116 as a function of the one or more model constraints 108 by identifying, using the AI-PII model 112, at least a PII datum 114 of the PII data 106, categorizing, using the AI-PII model 112, the at least a PII datum 114 to one or more categories 134 of a plurality of categories, and mapping, using the AI-PII model 112 the PII data 106 to the at least a data schema 116. As used in this disclosure, “AI-PII model” is an artificial intelligence-based processing engine configured to receive, analyze, and transform personally identifiable information (PII) data. The AI-PII model 112 is trained or rule-configured to identify individual PII datum 114, assign each datum to a corresponding category, and map the categorized PII into a target data schema. The AI-PII model 112 may include, without limitation, transformer-based neural networks, decision-tree logic, rule-based inference engines, or hybrid models that integrate machine learning with policy-driven constraints. In a non-limiting example, the AI-PII model 112 may include a transformer-based model, such as BERT (Bidirectional Encoder Representations from Transformers), RoBERTa, DistilBERT, or other large language models (LLMs) capable of contextual understanding of text. These models may be trained or fine-tuned to perform named entity recognition (NER) and token classification, allowing the AI-PII model 112 to identify PII datum 114 embedded within unstructured documents, such as emails, customer forms, or textual logs. The transformer model may also support multilingual PII recognition and adapt to domain-specific taxonomies. In a non-limiting example, the AI-PII model 112 may include a convolutional neural network (CNN), particularly when processing visual data or image-based documents containing PII. For instance, scanned forms, identification cards, handwritten signatures, or visual PDFs may be ingested into the system, and the CNN may be applied to detect relevant regions in the image that contain textual PII. The detected regions may then be passed through an optical character recognition (OCR) module for further semantic analysis and categorization. In a non-limiting example, the AI-PII model 112 may include a recurrent neural network (RNN), or more specifically, a long short-term memory (LSTM) network or gated recurrent unit (GRU), to process sequential or time-sensitive data inputs. This is particularly useful in scenarios where PII appears in ordered contexts such as call transcripts, chat logs, SMS messages, or clinical notes. The RNN architecture allows the model to maintain temporal context, improving the accuracy of categorization for PII datum 114 that depend on surrounding tokens. In a non-limiting example, the AI-PII model 112 may include a hybrid model combining a statistical classifier with rule-based inference. For example, without limitation, the model may use a logistic regression classifier or decision tree to estimate probabilities for various PII categories 134, while simultaneously applying predefined guardrails that restrict or validate outputs based on regulatory or internal policy constraints. This architecture allows for interpretable decision-making while retaining the flexibility of machine learning inference. In a non-limiting example, the AI-PII model 112 may incorporate unsupervised clustering algorithms, such as k-means clustering, hierarchical clustering, or DBSCAN, to group similar PII datum 114 or identify anomalous data that does not conform to known categories 134. This approach may be used during initial data ingestion or model tuning phases to discover new or emerging patterns in sensitive data that require schema updates or policy review. In a non-limiting example, the AI-PII model 112 may further include embedding-based similarity models, such as sentence-transformers (e.g., SBERT), word2vec, or fastText. These models may generate vector representations of new PII datum 114 and compare them to historical examples stored in a vector database such as FAISS, Milvus, or Pinecone. The similarity results may inform categorization and schema mapping decisions, particularly in edge cases where explicit labels are unavailable.

With continued reference to FIG. 1, as used in this disclosure, “data schema” is a predefined and structured framework that describes the organization, format, and expected attributes of data. A data schema 116 defines the names, data types, constraints, and relationships of fields to which PII data 106 may be mapped. The data schema 116 enables standardized data representation, interoperability between systems, and enforcement of compliance requirements, and may be implemented using formats such as JSON Schema, XML Schema Definition (XSD), or relational database models. As used in this disclosure, “PII datum” is an individual data element within a larger dataset that, alone or in combination with other information, can be used to identify a specific natural person. A PII datum 114 may include, without limitation, a person's full name, date of birth, home address, email address, social security number, or other information classified as personally identifiable under applicable data privacy regulations. As used in this disclosure, “category” is a predefined classification label assigned to a PII datum 114. In an embodiment, the category may denote the type or contextual role of the PII datum 114 within a data schema 116. Categories 134 may include, without limitation, “Contact Information,” “Government Identifiers,” “Financial Information,” “Location Data,” “Biometric Identifiers,” or other classifications relevant to regulatory frameworks, organizational policies, or industry best practices.

With continued reference to FIG. 1, in an embodiment, processor 102 is configured to map PII data 106 to a data schema 116 using an AI-PII model 112, which applies a structured sequence of operations directed by one or more model constraints 108. These constraints may include, for example and without limitation, requirements from the General Data Protection Regulation in the European Union, the Health Insurance Portability and Accountability Act in the United States, internal enterprise data policies, or rules specifying how data fields should be named, formatted, or linked. In a non-limiting example, the AI-PII model 112 initially performs identification of personally identifiable information datums within a given dataset. This process may be performed using a transformer-based deep learning model such as Bidirectional Encoder Representations from Transformers or a variant of it that has been fine-tuned for named entity recognition. The model may tokenize the incoming data and apply semantic analysis to detect elements that qualify as personally identifiable information datums. These datums may include full names, email addresses, street addresses, social security numbers, or dates of birth, and may be extracted from structured, semi-structured, or unstructured input formats. In a non-limiting example, the identified personally identifiable information datums are next passed into a categorization engine within the AI-PII model 112. This engine may use a neural classifier or a rule-based categorization framework to assign each personally identifiable information datum to a designated category. Categories 134 may include contact information, government-issued identifiers, financial information, biometric data, or health-related data. For example, a telephone number may be classified as contact information, while a driver's license number may be classified as a government-issued identifier. Categorization may take into account the surrounding context, the format of the data, and cross-field relationships within a record. In an embodiment, once each personally identifiable information datum has been assigned to a category, the AI-PII model 112 performs mapping to a target data schema 116. The mapping step involves determining the correct field or location within the schema for each categorized personally identifiable information datum. For example and without limitation, a categorized passport number may be mapped to a schema field labeled government_identifiers_passport_number. This mapping may be performed using a rule-based matching engine, a trained schema alignment model, or a hybrid system that evaluates similarity between datums and historical schema examples. In a non-limiting example, the AI-PII model 112 may also assess confidence scores associated with each mapping operation. If a particular mapping does not meet a predefined confidence threshold, the processor 102 may invoke a fallback mechanism such as rerouting the data for remediation or applying a secondary matching strategy. The mapping engine may also be connected to a schema registry service, which ensures that all mappings are valid under the currently accepted data schema 116 version. In an embodiment, the result of this mapping process is a fully structured output, in which PII data 106 has been assigned to specific fields within a standardized schema. This output may be used for secure storage, downstream compliance validation, access control enforcement, or audit tracking. The AI-PII model 112 may also generate metadata describing the mapping decision process, including traceability to constraint sources, applied rules, and confidence metrics.

With continued reference to FIG. 1, the at least a processor 102 may be further configured to receive a predefined data schema 118 of the at least a data schema 116 from a user interface 120. As used in this disclosure, “predefined data schema” is a structured and explicitly specified organization of data fields, types, formats, and relationships that is determined in advance of runtime. A predefined data schema 118 establishes a fixed blueprint for how data must be formatted, categorized, and stored, and may include field names, expected value types such as string, integer, or date, and structural hierarchies such as nested or relational mappings. The predefined data schema 118 enables consistent mapping of personally identifiable information datums across systems, enhances data integrity, and supports regulatory alignment. In a non-limiting example, a predefined data schema 118 may specify that full_name must be stored as a string, date_of_birth as a date object, and national_identifier within a secure, encrypted substructure. As used in this disclosure, “user interface” is a graphical, textual, or command-driven system component that enables a human user to interact with, input data to, or retrieve information from a computing system. A user interface 120 may include, without limitation, a web-based form, a command-line terminal, a graphical dashboard, or an application window that allows authorized users to submit predefined data schemas 118, configure model parameters, or provide manual overrides to system behavior. In a non-limiting example, the user interface 120 may be built using web technologies such as HyperText Markup Language, Cascading Style Sheets, and JavaScript frameworks, and may be hosted on platforms such as Amazon Web Services, Microsoft Azure, or private enterprise networks.

With continued reference to FIG. 1, in an embodiment, the at least a processor 102 may be configured to receive a predefined data schema 118 from a user interface 120 using one or more interactive technologies that enable human users to define, upload, or modify schema specifications. For example, without limitation, the user interface 120 may be implemented as a web-based dashboard that allows a user to input schema details using structured form fields, dropdown selectors, or text editors. The web interface may be built using web development frameworks such as React, Angular, or Vue.js and may be rendered in a browser environment. In a non-limiting example, the user may submit the predefined data schema 118 in a structured format such as JavaScript Object Notation or Extensible Markup Language through the user interface 120. Upon submission, the user interface 120 may transmit the schema to the processor 102 using a secure application programming interface call, using communication protocols such as HTTPS or WebSocket. The schema may include field definitions such as full_name, date_of_birth, email_address, or national_identifier, along with data types, allowed formats, and constraint metadata. Without limitation, the processor 102 may be configured to validate the predefined data schema 118 upon receipt by executing a parsing function or schema validator using tools such as Apache Avro, JSON Schema Validator, or custom validation libraries implemented in Python, JavaScript, or Java. Once validated, the schema may be loaded into memory or persisted in a schema registry or metadata store for use in subsequent mapping operations performed by the AI-PII model 112. In a non-limiting example, the user interface 120 may also provide version control features or schema templates, enabling users to select from approved schema definitions or retrieve historical versions stored in systems such as GitHub, GitLab, or enterprise content repositories. The interface may include user authentication and access control mechanisms, implemented using identity management systems such as OAuth, SAML, or Active Directory, to ensure that only authorized users can submit or edit predefined data schemas.

With continued reference to FIG. 1, the at least a processor 102 may be further configured to train the AI-PII model 112 on PII training data 122, wherein the PII training data 122 comprises historical PII data 124 mapped to historical data schemas 126. As used in this disclosure, “personally identifiable information (PII) training data” is a dataset or collection of datasets used to train, fine-tune, or validate the AI-PII model 112. The PII training data 122 contains labeled examples of personally identifiable information datums and their corresponding mappings to schema fields, enabling the AI-PII model 112 to learn how to identify, categorize, and map such datums accurately and consistently. The PII training data 122 may be used in supervised, semi-supervised, or self-supervised training regimes and may include both structured and unstructured input formats. As used in this disclosure, “historical personally identifiable information data” is PII data that has been previously processed, stored, or utilized within the system or organization and reflects real or representative instances of identifiable information that were subject to earlier data operations. Historical PII data 124 may include, without limitation, archived customer records, onboarding forms, government identification documents, and transaction logs that contain names, addresses, contact details, identification numbers, or similar identifiable fields. As used in this disclosure, “historical data schemas” are previously used, predefined structures into which historical PII data 124 has been mapped. Historical data schemas 126 define how fields were organized, formatted, or named in prior system configurations or deployments. These schemas may reflect changes over time in data governance rules, business processes, or regulatory standards. In a non-limiting example, a historical data schema may define the format of a full name field as a single string in one version and as separate first_name and last_name fields in a subsequent version.

With continued reference to FIG. 1, in an embodiment, processor 102 may be configured to train the AI-PII model 112 using PII training data 122 by performing one or more training workflows in a computing environment. For example, without limitation, the training process may begin by loading historical PII data 124 and corresponding historical data schemas 126 into memory from a secure data repository, such as an Amazon Simple Storage Service (S3) bucket, an Azure Data Lake, or an on-premises database. In a non-limiting example, the processor 102 may tokenize and pre-process the historical PII data 124 using natural language processing libraries such as spaCy, Hugging Face Transformers, or TensorFlow Text. Personally identifiable information datums such as names, dates of birth, email addresses, and identification numbers may be labeled based on their mappings in the historical data schemas 126. These labels may serve as ground truth targets for training. In an embodiment, the processor 102 may initiate a supervised learning pipeline, in which the AI-PII model 112 is trained to predict labels for each input token or field based on the examples in the training dataset. For example, without limitation, a transformer-based model such as Bidirectional Encoder Representations from Transformers (BERT) may be fine-tuned to perform named entity recognition by minimizing classification loss across labeled PII data in the historical training data. In a non-limiting example, the processor 102 may also perform training using multi-task learning, where the AI-PII model 112 is simultaneously optimized for multiple objectives, such as identifying personally identifiable information datums, categorizing them into regulatory categories 134, and mapping them to schema fields. This may be implemented using deep learning frameworks such as PyTorch Lightning or TensorFlow Extended. Without limitation, the processor 102 may evaluate the performance of the trained model using validation sets derived from held-out portions of the historical PII data 124. Metrics such as precision, recall, F1-score, and schema mapping accuracy may be computed, and results may be visualized using monitoring platforms such as MLflow, Weights & Biases, or TensorBoard. In an embodiment, the processor 102 may store the trained AI-PII model 112 in a model registry such as Amazon SageMaker Model Registry, Azure Machine Learning, or an internal Git-based system. The model may then be deployed for inference and updated periodically using continuous training or feedback loop pipelines, incorporating new PII training data 122 as it becomes available.

With continued reference to FIG. 1, the at least a processor 102 may be further configured to train the AI-PII model 112 using a reinforcement learning model 128, wherein the reinforcement learning model 128 is configured to assign rewards based on a classification and update a mapping policy based on a cumulative reward and the classification. As used in this disclosure, “reinforcement learning model” is a type of machine learning model that is trained to make a sequence of decisions by interacting with an environment, receiving feedback in the form of rewards or penalties, and adjusting its behavior to maximize cumulative reward over time. A reinforcement learning model 128 operates through exploration and exploitation, using trial-and-error learning to discover optimal strategies or policies. The AI-PII model 112 may include an agent that takes actions, a defined set of states, a reward function, and a policy for selecting actions. In an embodiment, the processor 102 may apply a reinforcement learning model 128 to train the AI-PII model 112 by defining the mapping of personally identifiable information datums to schema fields as a decision-making task. For example, without limitation, the reinforcement learning model 128 may receive a positive reward when the AI-PII model 112 correctly identifies and maps a personally identifiable information datum to its intended schema category, and a negative reward when it incorrectly classifies or misplaces the datum. In a non-limiting example, the reinforcement learning model 128 may use a policy gradient method, such as Proximal Policy Optimization or Advantage Actor-Critic, to refine the model's action-selection policy over multiple training episodes. The environment may simulate real-world constraints, including incomplete data, ambiguous categories 134, or evolving regulatory requirements. Feedback signals may be derived from validation checks, rule-based evaluators, or human-in-the-loop annotations.

With continued reference to FIG. 1, In a non-limiting example, processor 102 may apply a reinforcement learning model 128 to improve the accuracy and adaptability of the AI-PII model 112 during schema mapping tasks. In this embodiment, each mapping decision, such as assigning a personally identifiable information datum to a specific field in the data schema 116, is treated as an action. The processor 102 observes the current state of the input data, selects an action according to the current policy of the model, and receives a reward based on whether the action results in a correct and compliant mapping. For example, without limitation, the reinforcement learning model 128 may be trained using a simulation environment in which the AI-PII model 112 processes a sequence of historical records. If the model correctly maps a social security number to the appropriate government identifier field, the reinforcement learning model 128 may assign a positive reward. If the model instead incorrectly maps the same datum to a general string field or misses a required compliance flag, a negative reward may be applied. The reinforcement learning model 128 then adjusts the mapping policy to favor actions that historically led to higher cumulative rewards. In an embodiment, the reinforcement learning model 128 may also be configured to adapt to changing data schemas, user-defined constraints, or evolving regulatory requirements without requiring full retraining of the base model. This adaptive behavior is especially beneficial in enterprise data environments where policies and schema definitions may shift over time. Using a reinforcement learning model 128 improves the apparatus 100 by enabling the AI-PII model 112 to learn from operational outcomes rather than relying solely on static training datasets. It introduces a dynamic feedback mechanism where the model continuously refines its policy based on real-world results. This leads to increased accuracy, reduced reliance on manual corrections, and improved performance in edge cases where static rule sets or supervised learning may be insufficient. Moreover, the apparatus 100 becomes more robust to ambiguous or previously unseen personally identifiable information datums, enhancing both scalability and regulatory compliance across diverse data sources.

With continued reference to FIG. 1, as used in this disclosure, “rewards” are feedback signals generated in response to specific actions taken by the AI-PII model during schema mapping tasks. In an embodiment, the reward may include a positive value and a vegetive value. Without limitation, the positive value may indicate a desirable outcome such as correct mapping of a PII datum to a schema field. In an embodiment, the negative value may indicate an undesirable outcome such as incorrect or non-compliant mapping. As used in this disclosure, “classification” is the process by which the AI-PII model assigns a personally identifiable information datum to a specific field or category within a predefined data schema based on its characteristics, context, or content. As used in this disclosure, “mapping policy” is a set of learned decision-making rules or strategies that guide the AI-PII model in selecting how to classify PII data into schema fields. In an embodiment, the mapping policy may evolve over time based on observed outcomes and received rewards. As used in this disclosure, “cumulative reward” is the total numerical value of all rewards received by the AI-PII model over a sequence of classification actions. Without limitation, the cumulative reward may represent the overall effectiveness of the mapping policy in achieving accurate and compliant data mappings.

With continued reference to FIG. 1, the at least a processor 102 may be further configured to categorize, using the AI-PII model 112, the at least a PII datum 114 to the one or more categories 134 by identifying one or more key words 130 of the PII data 106 and classifying, using a classifier 132, the one or more key words 130 based on a rules-based function. As used in this disclosure, “key words” are text strings, tokenized terms, or semantic units present within PII data 106 that carry distinguishing characteristics or contextual signals useful for identifying or classifying a personally identifiable information datum. Key words 130 may include literal field names, surrounding labels, contextual phrases, or value patterns that enable accurate recognition of the nature or intent of the data. In a non-limiting example, key words 130 such as “phone,” “cell,” “mobile,” or “contact number” may indicate a phone number field, while key words 130 like “SSN,” “social security,” or “national ID” may signal a government-issued identifier. As used in this disclosure, “rules-based function” is a logical or algorithmic function composed of predefined conditions, constraints, or pattern-matching rules used to determine an outcome when processing data. A rules-based function may apply string matching, regular expressions, whitelist or blacklist filters, context-based thresholds, or deterministic mappings to classify or validate input. In a non-limiting example, a rules-based function may classify a key word as belonging to the “financial information” category if the key word appears within a list of known financial terms such as “bank account,” “routing number,” or “SWIFT code,” and if the associated value conforms to a known pattern such as a nine-digit numeric sequence.

With continued reference to FIG. 1, in an embodiment, processor 102 may identify one or more key words 130 within the PII data 106 by parsing the surrounding metadata, field names, or adjacent text. For example, without limitation, a field labeled “emergency contact email” may include key words 130 such as “contact” and “email,” which signal that the value should be evaluated as both contact information and an electronic identifier. The processor 102 may extract these key words 130 and input them into a classifier 132. In a non-limiting example, the classifier 132 may apply a rules-based function that checks whether the combination of key words 130 matches a pattern defined in a lookup table or policy file. If the key words 130 match a rule associated with the “Contact Information” category, the classifier 132 may assign the corresponding personally identifiable information datum to that category. Similarly, a rule may evaluate whether the term “taxpayer” appears near a numeric value, triggering classification into the “Government-Issued ID” category based on the rule that links known tax-related terms to sensitive identifiers. In an embodiment, the rules-based function enables the apparatus 100 to perform transparent and auditable classification, improving interpretability and trustworthiness in regulatory or enterprise settings. It may also serve as a fallback mechanism when machine learning confidence scores are below threshold, ensuring deterministic outcomes when probabilistic inference is uncertain.

Still referring to FIG. 1, processor 102 is configured to modify the data schema 116 based on a refinement datum 136, wherein the refinement datum 136 is generated based on a temporal datum 138 of the one or more model constraints 108. As used in this disclosure, “refinement datum” is a data element that represents an adjustment, update, or correction to a previously generated mapping, classification, or structural configuration. A refinement datum 136 may be derived from evaluation metrics, user feedback, detected inconsistencies, or evolving requirements, and is used to improve the quality, accuracy, or alignment of the data schema 116 with current standards or expectations. As used in this disclosure, “temporal datum” is a data element that encodes or references a specific point in time, a time window, or a recurring temporal condition that influences system behavior. A temporal datum 138 may include, without limitation, a timestamp, a date range, a versioning schedule, a compliance deadline, or any other time-based trigger that causes a corresponding adjustment in data processing logic. In an embodiment, processor 102 may generate a refinement datum 136 by detecting that a previously mapped personally identifiable information datum no longer aligns with an updated compliance rule that became effective after a specific date. For example, without limitation, a temporal datum 138 may indicate that on Jan. 1, 2025, new regulations require passport numbers to be split into separate fields for issuing country and identification number. Upon encountering data mapped under the previous schema, the processor 102 may generate a refinement datum 136 that instructs the system to restructure the relevant schema portion accordingly. In a non-limiting example, the temporal datum 138 may reference a rolling data lifecycle policy that requires anonymization of personally identifiable information datums after one year from the date of collection. Based on this temporal condition, the processor 102 may evaluate timestamps associated with stored records and generate refinement datums 136 that indicate which schema fields must be modified to reflect anonymized formats. For instance, a refinement datum 136 may specify that the “full_name” field be masked or replaced with a pseudonym field after the applicable date threshold is reached. In an embodiment, the ability to generate and apply refinement datums 136 based on temporal datums 138 enables the apparatus 100 to adapt data schemas over time, supporting compliance with evolving legal, technical, or operational requirements. This improves long-term reliability and regulatory responsiveness of the AI-PII model 112.

With continued reference to FIG. 1, the at least a processor 102 may be further configured to modify the data schema 116 by identifying one or more gap datums 140 and determining, using an automated feedback loop 142, a remediation datum 144 based on the one or more identified gap datums 140. As used in this disclosure, “gap datum” is a data element, condition, or indicator that reflects a deficiency, inconsistency, omission, or structural misalignment within the data schema 116 relative to an expected schema configuration, constraint, or reference standard. A gap datum 140 may be identified through comparison with predefined schema definitions, validation rules, historical mapping patterns, or regulatory requirements. For example, without limitation, a gap datum 140 may represent a missing field, an incorrectly categorized personally identifiable information datum, or a field populated in an incompatible format. As used in this disclosure, “automated feedback loop” is a self-regulating processing mechanism configured to evaluate system outputs, detect deviations or errors, and generate corrective actions without requiring manual intervention. An automated feedback loop 142 continuously monitors the behavior of the AI-PII model 112 and responds to gaps, anomalies, or misclassifications by applying rule-based logic, learning-based adjustments, or constraint-driven corrections. The feedback loop may include components such as data validators, policy enforcers, machine learning retraining triggers, or confidence score thresholds. As used in this disclosure, “remediation datum” is a corrective data element, action directive, or schema adjustment that is generated in response to one or more gap datums 140 to resolve a detected inconsistency, restore schema compliance, or improve mapping accuracy. A remediation datum 144 may include, without limitation, an instruction to reclassify a personally identifiable information datum, a replacement schema mapping directive, or a structural transformation rule to realign the data schema 116 with system expectations. In a non-limiting example, processor 102 may identify a gap datum 140 indicating that a telephone number field has been mapped to a free-text string field rather than to a validated contact information field. The automated feedback loop 142 may compare this result to the predefined data schema 118 and generate a remediation datum 144 instructing the system to reassign the telephone number to a dedicated phone_number field with formatting constraints. In another non-limiting example, a gap datum 140 may indicate that a required personally identifiable information category such as government-issued identifier is missing from a particular schema mapping instance. The automated feedback loop 142 may evaluate prior mapping patterns, user-defined rules, or external constraints and generate a remediation datum 144 to infer or request the missing mapping, or to flag the record for exception handling. In an embodiment, the use of gap datums 140, automated feedback loops 142, and remediation datums 144 may allow the apparatus 100 to improve schema mapping precision, reduce manual correction overhead, and dynamically respond to evolving data quality expectations and compliance standards.

Still referring to FIG. 1, processor 102 is configured to generate, using the AI-PII model 112, an output 146 as a function of the refinement datum 136 and the data schema 116. As used in this disclosure, “output” is a structured, machine-readable result generated by the AI-PII model 112 that reflects the finalized organization, classification, and schema mapping of PII data 106 after application of one or more refinement datums 136. The output 146 may represent a completed and validated version of the input data that has been processed according to system rules, user-defined constraints, and compliance-driven schema requirements. The output 146 may be produced in a format suitable for storage, transmission, integration, or regulatory reporting and may include metadata describing the mapping logic, transformation history, and confidence levels associated with the result. In an embodiment, processor 102 may generate the output 146 by first applying a refinement datum 136 to adjust the previously data schema 116. For example, without limitation, if a refinement datum 136 indicates that a government-issued identifier must now include a country-of-issuance subfield, the processor 102 may modify the schema and update the associated data accordingly. Once the mapping is refined, the processor 102 compiles the structured result, including personally identifiable information datums assigned to specific schema fields, into a finalized output. In a non-limiting example, the output 146 may be represented as a JSON object, Extensible Markup Language document, or relational database entry, containing fields such as full_name, date_of_birth, national_identifier, and contact_number, each properly categorized and formatted in alignment with the current schema version. The output 146 may also include a transformation log or audit trail describing the refinement datums 136 applied and the reasoning behind schema modifications, which may be used for traceability and governance. In an embodiment, the generation of the output 146 allows the apparatus 100 to deliver structured, compliant, and trustworthy data products that may be consumed by downstream applications such as data lakes, privacy compliance tools, identity verification services, or secure storage platforms.

With continued reference to FIG. 1, the output 146 may include a data dictionary 148 for the PII data 106. As used in this disclosure, “data dictionary” is a structured reference artifact that describes the metadata, definitions, classifications, and schema-level attributes associated with each field or element of the PII data 106. A data dictionary 148 includes, without limitation, field names, data types, value constraints, allowable formats, semantic categories, and source information. The data dictionary 148 provides a comprehensive and machine-readable description of how personally identifiable information datums are represented and understood within a given schema, and may be used to enforce consistency, support validation, facilitate integration, and ensure compliance with regulatory standards. In an embodiment, the processor 102 may generate a data dictionary 148 as part of the output 146 by compiling metadata related to each identified and mapped personally identifiable information datum. For example, without limitation, the data dictionary 148 may define that the field “full_name” is of type string, belongs to the category “Contact Information,” accepts alphabetic characters and spaces only, and is derived from a source labeled “intake_form_2025.” Similarly, the dictionary may indicate that “date_of_birth” is a date field required for identity verification and formatted as YYYY-MM-DD. In a non-limiting example, the data dictionary 148 may be formatted as a standalone JSON, YAML, or CSV file, or embedded within a broader schema definition document. It may include links or references to external regulatory taxonomies, such as mappings to categories 134 defined by the National Institute of Standards and Technology, the General Data Protection Regulation, or internal enterprise classification systems. In an embodiment, the inclusion of a data dictionary 148 within the output 146 enhances the interpretability, transparency, and traceability of the processing behavior of the AI-PII model 112. It may allow downstream systems, auditors, or analysts to understand exactly how each field was derived, how it is classified, and what rules govern its representation. This improves governance and supports automated validation, lineage tracking, and schema-driven data management practices.

With continued reference to FIG. 1, the at least a processor 102 may be further configured to retrieve, using an application programming interface 150, regulatory data 152 of the one or more model constraints 108 from an external source 154, conditionally update, using the at least a processor 102, the regulatory data 152 based on a temporal datum 138, and modify, using the at least a processor 102, the output 146 as a function of the updated regulatory data 152. As used in this disclosure, “regulatory data” is a collection of legal, compliance, or policy-based requirements that govern the identification, handling, categorization, storage, processing, or disclosure of PII data 106. Regulatory data 152 may include, without limitation, jurisdiction-specific privacy laws, such as the General Data Protection Regulation in the European Union, the Health Insurance Portability and Accountability Act in the United States, or the California Consumer Privacy Act, as well as guidelines from industry frameworks or standards bodies. Regulatory data 152 may define rules regarding data retention, access permissions, required fields, formatting constraints, consent models, and lawful processing grounds. As used in this disclosure, “external source” is a system, service, repository, or authoritative resource located outside the local computing environment from which regulatory data 152 may be obtained. An external source 154 may include, without limitation, a government compliance portal, an industry standards database, a third-party regulatory intelligence platform, or a public or private application programming interface 150 that publishes updated regulatory requirements. In an embodiment, processor 102 may be configured to retrieve regulatory data 152 from an external source 154 using an application programming interface 150 request. For example, without limitation, processor 102 may issue a structured Hypertext Transfer Protocol Secure request to a public regulatory endpoint, such as an open data service provided by a government agency or a commercial compliance API such as OneTrust, TrustArc, or PrivacyCheq. The request may return machine-readable content in JavaScript Object Notation or Extensible Markup Language format, which is parsed and stored for integration into model constraints 108. In a non-limiting example, processor 102 may use a web crawler module or web scraping framework such as Scrapy or Selenium when the regulatory data 152 is not available through a formal application programming interface 150. In this embodiment, processor 102 may extract legal text, schema tables, or policy change announcements from government websites or industry newsletters and convert the content into structured rule sets through natural language processing and rule-extraction algorithms. Without limitation, processor 102 may also include a versioning engine that monitors the retrieved regulatory data 152 and evaluates changes based on one or more temporal datums 138. For example, a temporal datum 138 may specify an effective date for a new compliance requirement, such as a restriction on storing biometric identifiers after a certain date. If the current date matches or surpasses the temporal datum 138, processor 102 may automatically update the applicable regulatory constraints and trigger downstream updates to the output 146 of the AI-PII model 112. In an embodiment, upon updating the regulatory data 152, processor 102 may modify the output 146 accordingly. For example, if the updated regulatory data 152 requires masking or redaction of national identifiers, processor 102 may apply a transformation function to remove, truncate, or tokenize the affected personally identifiable information datums in the final output. This allows the apparatus 100 to remain dynamically compliant and responsive to evolving legal obligations without requiring manual reconfiguration.

With continued reference to FIG. 1, the at least a processor 102 may be further configured to transmit the output 146 to one or more downstream models 156, wherein the one or more downstream models 156 is configured to receive the output 146 and execute a downstream command 158 as a function of the output 146. As used in this disclosure, “downstream model” is a software-based system, machine learning model, inference engine, automation framework, or decision logic module that is positioned to receive and process the output 146 of the AI-PII model 112 as part of a broader computational workflow. A downstream model may consume structured outputs, such as data schemas or data dictionaries, and use them to perform additional tasks such as validation, anonymization, risk scoring, access control, audit trail generation, or triggering external system actions. As used in this disclosure, “downstream command” is a programmatic instruction, operational directive, or automated task that is executed by a downstream model in response to the output 146 generated by the AI-PII model 112. A downstream command 158 may include, without limitation, storing the output 146 in a secure database, invoking a compliance notification system, applying data masking, triggering an access control rule, initiating a regulatory report, or updating a consent ledger. In an embodiment, processor 102 may transmit the output 146, such as a structured record with mapped personally identifiable information fields and an associated data dictionary 148, to one or more downstream models 156 using a secure communication interface, such as a RESTful application programming interface 150 or a message bus implemented using Apache Kafka, RabbitMQ, or AWS EventBridge. The output 146 may be serialized in a machine-readable format such as JavaScript Object Notation or Avro schema and may include metadata indicating schema version, refinement history, and applicable regulatory constraints. In a non-limiting example, a downstream model may receive the output 146 and evaluate it using a compliance rule engine. If the data includes high-risk personally identifiable information fields, the downstream model may execute a downstream command 158 to apply redaction or masking using a privacy-preserving transformation module. In another example, the downstream model may execute a downstream command 158 to initiate an automated notification to a data protection officer or to store the output 146 in an encrypted archive managed by a data retention policy engine. In an embodiment, the use of downstream models 156 and downstream commands 158 may allow the apparatus 100 to integrate seamlessly into broader enterprise architectures, enabling automated workflows that enforce regulatory, operational, and security controls in real time based on the structure and content of the output 146.

With continued reference to FIG. 1, the at least a processor 102 may display, using a graphical user interface, the output 146 at a downstream device. A “graphical user interface,” as used herein, is a graphical form of user interface 120 that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 1, in an embodiment, the graphical user interface and an event handler may operate together to enable seamless interaction between the user and the apparatus 100. The GUI serves as the visual and interactive layer through which the user engages with the apparatus 100, presenting elements such as buttons, sliders, input fields, and informational displays. The event handler, on the other hand, functions as the underlying mechanism that monitors and responds to user interactions with the GUI. For example, when a user clicks a button on the GUI to request an explanation of a concept, the event handler may detect the click event, identify its context, and trigger the appropriate processes within the apparatus 100 to generate a tailored response. This interplay may ensure dynamic and responsive system behavior, as the event handler processes various input events such as clicks, taps, keystrokes, or voice commands, and relays these inputs to the relevant system components. The GUI subsequently updates to reflect the system's responses, such as displaying output, modifying visual elements, or providing real-time feedback. Together, the GUI and event handler create an intuitive and interactive experience, bridging user actions and system functionality to achieve efficient and personalized outcomes.

With continued reference to FIG. 1, an “event handler,” as used in this disclosure, is a module, data structure, function, and/or routine that performs an action in response to an event. For instance, and without limitation, an event handler may record data corresponding to user selections of previously populated fields such as drop-down lists and/or text auto-complete and/or default entries, data corresponding to user selections of checkboxes, radio buttons, or the like, potentially along with automatically entered data triggered by such selections, user entry of textual data using a keyboard, touchscreen, speech-to-text program, or the like. Event handler may generate prompts for further information, may compare data to validation rules such as requirements that the data in question be entered within certain numerical ranges, and/or may modify data and/or generate warnings to a user in response to such requirements.

With continued reference to FIG. 1, as used in this disclosure, a “visual element” is a component or feature within a system, display, or interface that conveys information through visual means. In a non-limiting example, the visual element may include text, images, icons, shapes, colors, and/or other graphical components designed to be perceived by the user. In a non-limiting example, the visual element may aid in communication, navigation, and/or interaction with the system. Without limitation, the visual element may be used to enhance user experience, guide behavior, and/or represent data visually in an intuitive or informative way. A visual element may include data transmitted to display device, client device, and/or graphical user interface. In some embodiments, visual element may be interacted with. For example, visual element may include an interface, such as a button or menu. In some embodiments, visual element may be interacted with using a user device such as a smartphone, tablet, smartwatch, or computer.

With continued reference to FIG. 1, in an embodiment, the apparatus 100 and or the downstream device may include a data structure. As used in this disclosure, “data structure” is a way of organizing data represented in a specialized format on a computer configured such that the information can be effectively presented in a graphical user interface. In some cases, the data structure includes any input data. In some cases, the data structure contains data and/or rules used to visualize the graphical elements within a graphical user interface. In some cases, the data structure may include any data described in this disclosure. In some cases, the data structure may be configured to modify the graphical user interface, wherein data within the data structure may be represented visually by the graphical user interface. In some cases, the data structure may be continuously modified and/or updated by processor 102, wherein elements within graphical user interface may be modified as a result. In some cases, processor 102 may be configured to transmit display device and or the downstream device the data structure. Transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio, and microwave data and/or signals, combinations thereof, and the like, among others. Processor 102 may transmit the data described above to a database wherein the data may be accessed from the database. Processor 102 may further transmit the data above to a display device, client device, or another computing device. The data structure may serve as the organizational framework that stores, retrieves, and manages data required for processing events and updating the GUI. The data structure may act as a bridge between the user's input, captured by the event handler, and the output 146 displayed on the GUI, ensuring that information is handled efficiently and accurately throughout the interaction. For example, without limitation, when a user interacts with a dropdown menu in the GUI to select a topic, the event handler may capture this input and accesses a data structure. The data structure may retrieve the relevant information such as, text explanations, videos, or interactive exercises, and passes it back to the event handler, which may then trigger the appropriate updates to the GUI. In another embodiment, the data structure may also maintain the state of the system, tracking user progress, preferences, and session history. For instance, without limitation, a hash table may store user specific configurations which the event handler references when processing interactions. The GUI may then dynamically adapt to display content aligned with these configurations. This integration may ensure that user inputs are seamlessly translated into meaningful system outputs, with the data structure enabling rapid access, consistency, and scalability throughout the process. As used in this disclosure, a “hash table” is a data structure that stores data in a way that allows for fast retrieval, insertion, and deletion of elements. The hash table may organize data into key-value pairs, where each key is unique and used to identify its corresponding value. A hash table may use a hash function to compute an index, or hash code, from the key, which determines where the key-value pair is stored within an array or list.

With continued reference to FIG. 1, as used in this disclosure, an “interactive element” is a component or feature within a graphical user interface (GUI) that allows users to perform actions, provide input, or engage with the apparatus 100. Interactive elements may be designed to facilitate two-way communication between the user and the system, enabling the user to influence the behavior of the apparatus 100 or obtain feedback in response to their actions. Examples of interactive elements may include buttons, dropdown menus, sliders, checkboxes, input fields, and hyperlinks. More advanced interactive elements may include drag-and-drop interfaces, interactive diagrams, or dynamically updating content areas that respond to user actions in real time. The interactive elements may enhance user engagement by providing intuitive and responsive mechanisms for interacting with the system. Interactive elements may operate by responding to user actions such as clicks, taps, swipes, or keyboard inputs, and triggering predefined system behaviors or processes. The execution of the interactive elements may require a combination of front-end and back-end technologies that work together to provide seamless functionality and user interaction. On the front end, technologies such as HTML and CSS may define the structure, appearance, and layout of the interactive elements, while JavaScript may enable dynamic functionality. For example, without limitation, JavaScript may detect when the user clicks a button and trigger actions or animations. Front-end frameworks like React, Angular, or Vue.js may further enhance development by offering reusable components and efficient rendering mechanisms. On the back end, the system may process the user's input, retrieve the necessary data, and communicate with the front end to provide an appropriate response. APIs may act as a bridge between the front end and back end, facilitating data transfer, such as sending a user's form submission to the server and retrieving processed results. Server-side logic, implemented using languages like Python, Java, or Node.js, may handle input processing and return relevant data. Additional supporting technologies may ensure the smooth operation of interactive elements. Event listeners, for instance, may continuously monitor for specific actions like mouse clicks or text entries, executing code when such events are detected. Efficient data structures, such as hash tables or dictionaries, may store interactive state data, such as user preferences or settings, for quick access and updates. Databases, including MySQL or MongoDB, may manage and store the data required for interactive features, such as user profiles or historical activity. Communication technologies may also help maintain the responsiveness of interactive elements. AJAX (Asynchronous Javascript and XML) may allow the front end to update portions of a web page without requiring a full page reload, enhancing responsiveness. WebSockets may provide real-time interaction capabilities, such as live chats or collaborative tools, by enabling persistent communication between the client and the server. Without limitation, the apparatus 100 may include one or more APIs. As used in this disclosure, an “application programming interface (API)” is a set of defined protocols, tools, and methods that allow different software applications, systems, or components to communicate and interact with each other. An API may act as an intermediary that enables a client application, such as a user-facing app, to send requests to a server or service and receive the necessary responses, facilitating seamless integration and functionality across diverse systems.

With continued reference to FIG. 1, as used in this disclosure, “downstream device” is a device that accesses and interacts with apparatus 100. For instance, and without limitation, downstream device may include a remote device and/or apparatus 100. In a non-limiting embodiment, downstream device may be consistent with a computing device as described in the entirety of this disclosure. Without limitation, the downstream device may include a display device. As used in this disclosure, a “display device” refers to an electronic device that visually presents information to the entity. In some cases, display device may be configured to project or show visual content generated by computers, video devices, or other electronic mechanisms. In some cases, display device may include a liquid crystal display (LCD), a cathode ray tube (CRT), a plasma display, a light emitting diode (LED) display, and any combinations thereof. In a non-limiting example, one or more display devices may vary in size, resolution, technology, and functionality. Display device may be able to show any data elements and/or visual elements as listed above in various formats such as, textural, graphical, video among others, in either monochrome or color. Display device may include, but is not limited to, a smartphone, tablet, laptop, monitor, tablet, and the like. Display device may include a separate device that includes a transparent screen configured to display computer generated images and/or information. In some cases, display device may be configured to present a graphical user-interface (GUI) to a user, wherein a user may interact with a GUI. In some cases, a user may view a GUI through display. Additionally, or alternatively, processor 102 be connected to display device. In one or more embodiments, transmitting the output 146 may include displaying the output 146 at display device using a visual interface.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

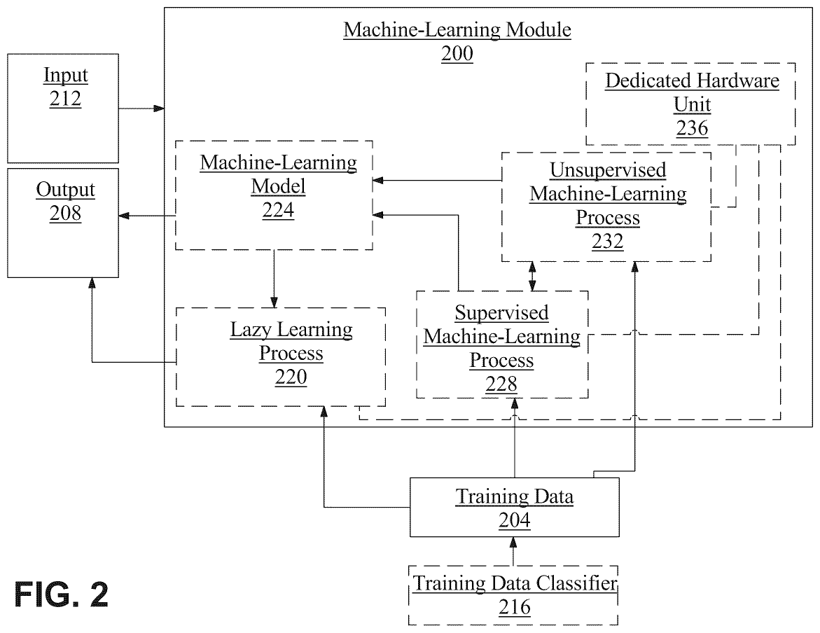

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example inputs may include PII data and outputs may include the output as described in FIG. 1.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to categories of PII data.

Still referring to FIG. 2, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 2, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 2, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 2, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 2, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 2, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{n e w} = \frac{X - {X}_{m i n}}{{X}_{m ax} - {X}_{m i n}} .$$

Feature scaling may include mean normalization, which involves use of a mean value of a set and/or subset of values, Xₘₑₐₙ with maximum and minimum values:

$${X}_{n e w} = \frac{X - {X}_{m e a n}}{{X}_{m ax} - {X}_{m i n}} .$$

Feature scaling may include standardization, where a difference between X and Xₘₑₐₙ is divided by a standard deviation σ of a set or subset of values:

$${X}_{n e w} = \frac{X - {X}_{m e a n}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{n e w} = \frac{X - {X}_{median}}{IQR} .$$

Persons skilled in the art, upon reviewing the entirety of this disclosure, will be aware of various alternative or additional approaches that may be used for feature scaling.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include PII data as described above as inputs, the output such as the data dictionary as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task clastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

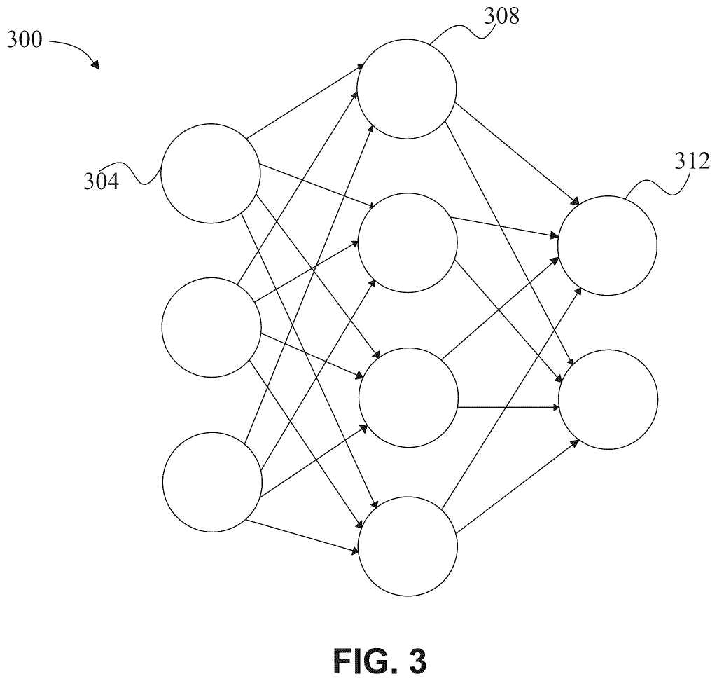

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

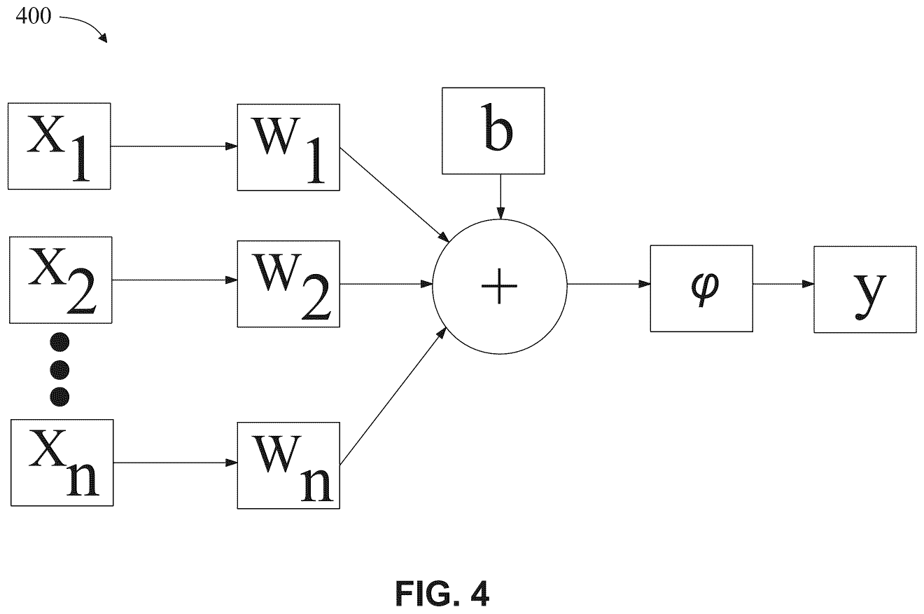

Referring now to FIG. 4, an exemplary embodiment of a node 400 of a neural network is illustrated. A node may include, without limitation, a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max (0, x), a “leaky” and/or “parametric” rectified linear unit function such as ƒ(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid (x), a Gaussian error linear unit function such as f(x)=a(1+tanh(2/π(x+bx^{T}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

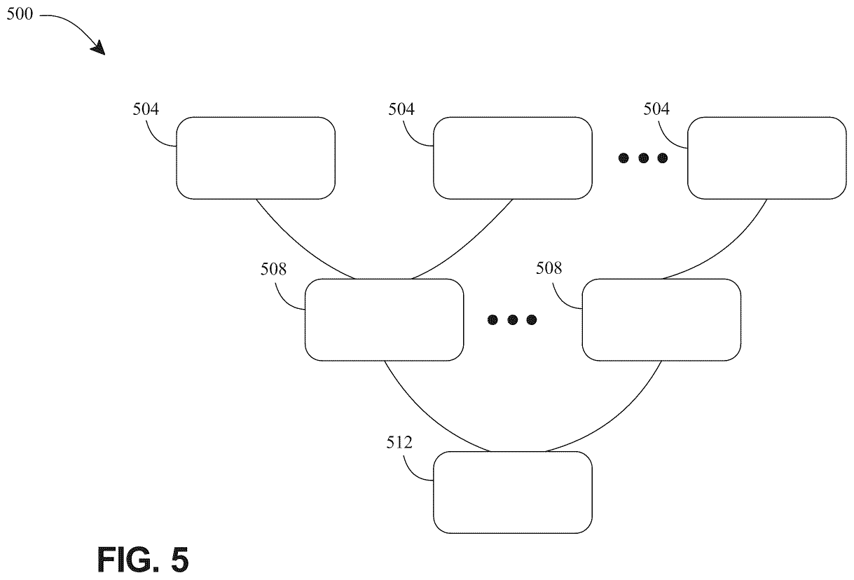

Referring now to FIG. 5, an exemplary embodiment of a cryptographic accumulator 500 is illustrated. A “cryptographic accumulator,” as used in this disclosure, is a data structure created by relating a commitment, which may be smaller amount of data that may be referred to as an “accumulator” and/or “root,” to a set of elements, such as lots of data and/or collection of data, together with short membership and/or nonmembership proofs for any element in the set. In an embodiment, these proofs may be publicly verifiable against the commitment. An accumulator may be said to be “dynamic” if the commitment and membership proofs can be updated efficiently as elements are added or removed from the set, at unit cost independent of the number of accumulated elements; an accumulator for which this is not the case may be referred to as “static.” A membership proof may be referred to as a as a “witness” whereby an element existing in the larger amount of data can be shown to be included in the root, while an element not existing in the larger amount of data can be shown not to be included in the root, where “inclusion” indicates that the included element was a part of the process of generating the root, and therefore was included in the original larger data set. Cryptographic accumulator 500 has a plurality of accumulated elements 504, each accumulated element 504 generated from a lot of the plurality of data lots. Accumulated elements 504 are created using an encryption process, defined for this purpose as a process that renders the lots of data unintelligible from the accumulated elements 504; this may be a one-way process such as a cryptographic hashing process and/or a reversible process such as encryption. Cryptographic accumulator 500 further includes structures and/or processes for conversion of accumulated elements 504 to root 512 element. For instance, and as illustrated for exemplary purposes in FIG. 5 cryptographic accumulator 500 may be implemented as a Merkle tree and/or hash tree, in which each accumulated element 504 created by cryptographically hashing a lot of data. Two or more accumulated elements 504 may be hashed together in a further cryptographic hashing process to produce a node 508 element; a plurality of node 508 elements may be hashed together to form parent nodes 508, and ultimately a set of nodes 508 may be combined and cryptographically hashed to form root 512. Contents of root 512 may thus be determined by contents of nodes 508 used to generate root 512, and consequently by contents of accumulated elements 504, which are determined by contents of lots used to generate accumulated elements 504. As a result of collision resistance and avalanche effects of hashing algorithms, any change in any lot, accumulated element 504, and/or node 508 is virtually certain to cause a change in root 512; thus, it may be computationally infeasible to modify any element of Merkle and/or hash tree without the modification being detectable as generating a different root 512. In an embodiment, any accumulated element 504 and/or all intervening nodes 508 between accumulated element 504 and root 512 may be made available without revealing anything about a lot of data used to generate accumulated element 504; lot of data may be kept secret and/or demonstrated with a secure proof as described below, preventing any unauthorized party from acquiring data in lot.

Alternatively or additionally, and still referring to FIG. 5, cryptographic accumulator 500 may include a “vector commitment” which may act as an accumulator in which an order of elements in set is preserved in its root 512 and/or commitment. In an embodiment, a vector commitment may be a position binding commitment and can be opened at any position to a unique value with a short proof (sublinear in the length of the vector). A Merkle tree may be seen as a vector commitment with logarithmic size openings. Subvector commitments may include vector commitments where a subset of the vector positions can be opened in a single short proof (sublinear in the size of the subset). Persons skilled in the art, upon reviewing the entirety of this disclosure, will be aware of various alternative or additional cryptographic accumulators 500 that may be used as described herein. In addition to Merkle trees, accumulators may include without limitation RSA accumulators, class group accumulators, and/or bi-linear pairing-based accumulators. Any accumulator may operate using one-way functions that are easy to verify but infeasible to reverse, i.e., given an input it is easy to produce an output of the one-way function but given an output it is computationally infeasible and/or impossible to generate the input that produces the output via the one-way function. For instance, and by way of illustration, a Merkle tree may be based on a hash function as described above. Data elements may be hashed and grouped together. Then, the hashes of those groups may be hashed again and grouped together with the hashes of other groups; this hashing and grouping may continue until only a single hash remains. As a further non-limiting example, RSA and class group accumulators may be based on the fact that it is infeasible to compute an arbitrary root of an element in a cyclic group of unknown order, whereas arbitrary powers of elements are easy to compute. A data element may be added to the accumulator by hashing the data element successively until the hash is a prime number and then taking the accumulator to the power of that prime number. The witness may be the accumulator prior to exponentiation. Bi-linear paring-based accumulators may be based on the infeasibility found in elliptic curve cryptography, namely that finding a number k such that adding P to itself k times results in Q is impractical, whereas confirming that, given 4 points P, Q, R, S, the point, P needs to be added as many times to itself to result in Q as R needs to be added as many times to itself to result in S, can be computed efficiently for certain elliptic curves.

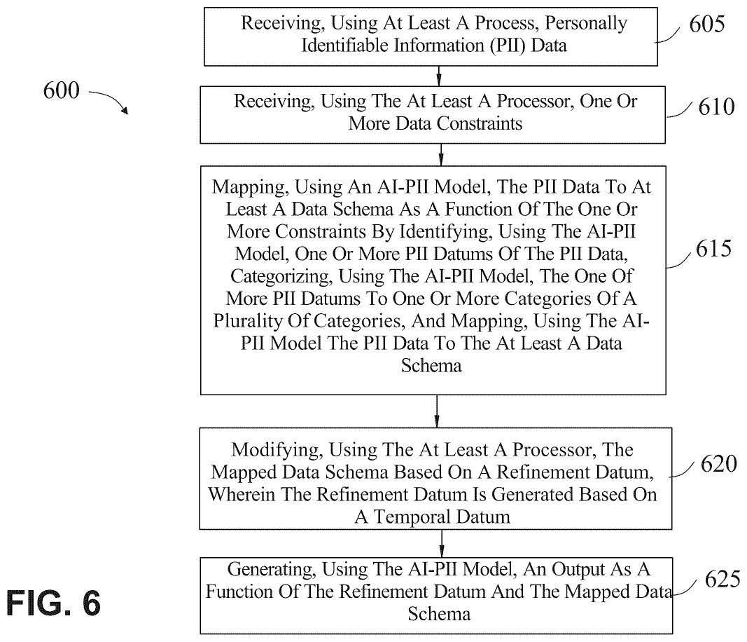

Referring now to FIG. 6, a flow diagram of an exemplary method 600 for generating an output using an AI-PII model is illustrated. At step 605, method 600 includes receiving, using at least a process, personally identifiable information (PII) data. This may be implemented as described and with reference to FIGS. 1-5.

Still referring to FIG. 6, at step 610, method 600 includes receiving, using the at least a processor, one or more model constraints. In an embodiment, the one or more data constraints may include internal data, wherein the at least a processor is further configured to receive the internal data. The methodology involves the meticulous coding of rules that the AI must adhere to. These rules are designed based on regulatory standards, data management best practices, and specific business requirements. By coding these rules, a structured environment is created where the AI operates within well-defined boundaries, minimizing the risk of inconsistent results. This may be implemented as described and with reference to FIGS. 1-5.

Still referring to FIG. 6, at step 615, method 600 includes mapping, using an AI-PII model, the PII data to at least a data schema as a function of the one or more model constraints by identifying, using the AI-PII model, at least a PII datum of the PII data, categorizing, using the AI-PII model, the at least a PII datum to one or more categories of a plurality of categories, and mapping, using the AI-PII model, the PII data to the at least a data schema. In an embodiment, the at least a processor may be further configured to receive a predefined data schema of the at least a data schema from a user interface. In an embodiment, the at least a processor may be further configured to train the AI-PII model on PII training data, wherein the PII training data comprises historical PII data mapped to historical data schemas. In an embodiment, the at least a processor may be further configured to train the AI-PII model using a reinforcement learning model. In an embodiment, the at least a processor may be further configured to categorize, using the AI-PII model, the one of more PII datums to the one or more categories by identifying one or more key words of the PII data and classifying, using a classifier, the one or more key words based on a rules-based function. This may be implemented as described and with reference to FIGS. 1-5.

Still referring to FIG. 6, at step 620, method 600 includes modifying, using the at least a processor, the data schema based on a refinement datum, wherein the refinement datum is generated based on a temporal datum of the one or more model constraints. In an embodiment, the at least a processor may be further configured to modify the data schema by identifying one or more gap datums and determining, using an automated feedback loop, a remediation datum based on the one or more identified gap datums. This may be implemented as described and with reference to FIGS. 1-5.

Still referring to FIG. 6, at step 625, method 600 includes generating, using the AI-PII model, an output as a function of the refinement datum and the data schema. In an embodiment, the output may include a data dictionary for the PII data. In an embodiment, the at least a processor may be further configured to retrieve, using an application programming interface, regulatory data of the one or more data constraints from an external source, conditionally update, using the at least a processor, the regulatory data based on a temporal datum, and modify, using the at least a processor, the output as a function of the updated regulatory data. In an embodiment, the at least a processor may be further configured to transmit the output to one or more downstream models, wherein the one or more downstream models is configured to receive the output and execute a downstream command as a function of the output. This may be implemented as described and with reference to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

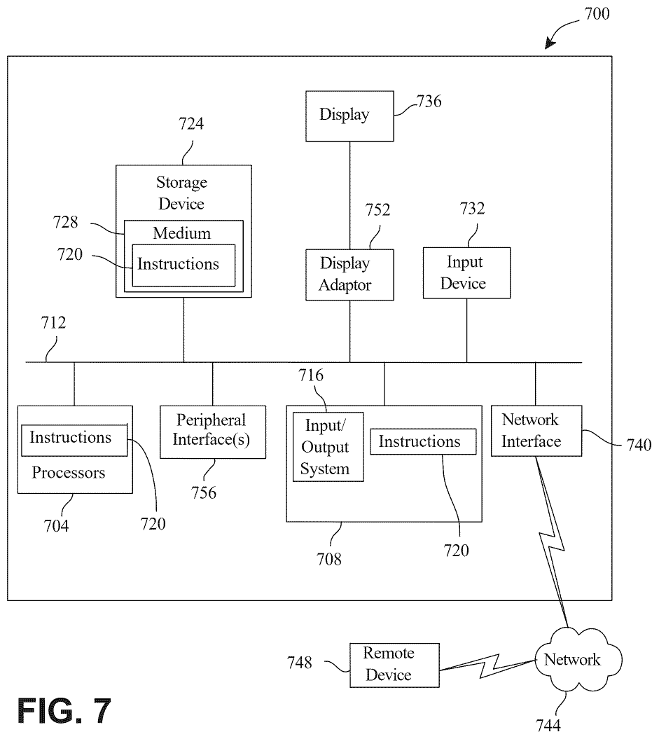

FIG. 7 shows a diagrammatic representation of one embodiment of computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display device 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for generating an output using an artificial intelligence personally identifiable information (AI-PII) model, wherein the apparatus comprises:
at least a computing device, wherein the computing device comprises:
a memory; and
at least a processor communicatively connected to the memory, wherein the memory contains instructions configuring the at least a processor to:
receive, using the at least a processor, personally identifiable information (PII) data;
receive, using the at least a processor, one or more model constraints;
map, using an AI-PII model, the PII data to at least a data schema as a function of the one or more model constraints by:
identifying, using the AI-PII model, at least a PII datum of the PII data;
categorizing, using the AI-PII model, the at least a PII datum to one or more categories of a plurality of categories; and
mapping, using the AI-PII model, the PII data to the at least a data schema;
modify, using the at least a processor, the data schema based on a refinement datum, wherein the refinement datum is generated based on a temporal datum of the one or more model constraints; and
generate, using the AI-PII model, an output as a function of the refinement datum and the data schema.

2. The apparatus of claim 1, wherein the one or more model constraints comprises internal data.

3. The apparatus of claim 1, wherein the output comprises a data dictionary for the PII data.

4. The apparatus of claim 1, wherein the at least a processor is further configured to:
retrieve, using an application programming interface, regulatory data of the one or more model constraints from an external source;
conditionally update, using the at least a processor, the regulatory data based on the temporal datum; and
modify, using the at least a processor, the output as a function of the updated regulatory data.

5. The apparatus of claim 1, wherein the at least a processor is further configured to receive a predefined data schema of the at least a data schema from a user interface.

6. The apparatus of claim 1, wherein the at least a processor is further configured to modify the data schema by:
identifying one or more gap datums; and
determining, using an automated feedback loop, a remediation datum based on the one or more identified gap datums.

7. The apparatus of claim 1, wherein the at least a processor is further configured to train the AI-PII model on PII training data, wherein the PII training data comprises historical PII data mapped to historical data schemas.

8. The apparatus of claim 1, wherein the at least a processor is further configured to train the AI-PII model using a reinforcement learning model, wherein the reinforcement learning model is configured to:
assign rewards based on a classification; and
update a mapping policy based on a cumulative reward and the classification.

9. The apparatus of claim 1, wherein the at least a processor is further configured to categorize, using the AI-PII model, the at least a PII datum to the one or more categories by:
identifying one or more key words of the PII data; and
classifying, using a classifier, the one or more key words based on a rules-based function.

10. The apparatus of claim 1, wherein the at least a processor is further configured to transmit the output to one or more downstream models, wherein the one or more downstream models is configured to:
receive the output; and
execute a downstream command as a function of the output.

11. A method for generating an output using an artificial intelligence personally identifiable information (AI-PII) model, wherein the method comprising:
receiving, using at least a processor, personally identifiable information (PII) data;
receiving, using the at least a processor, one or more model constraints;
mapping, using an AI-PII model, the PII data to at least a data schema as a function of the one or more model constraints by:
identifying, using the AI-PII model, at least a PII datum of the PII data;
categorizing, using the AI-PII model, the at least a PII datum to one or more categories of a plurality of categories; and
mapping, using the AI-PII model, the PII data to the at least a data schema;
modifying, using the at least a processor, the data schema based on a refinement datum, wherein the refinement datum is generated based on a temporal datum of the one or more model constraints; and
generating, using the AI-PII model, an output as a function of the refinement datum and the data schema.

12. The method of claim 11, further comprising receiving, using the at least a processor, internal data of the one or more model constraints.

13. The method of claim 11, wherein the output comprises a data dictionary for the PII data.

14. The method of claim 11, further comprising:
retrieving, using an application programming interface, regulatory data of the one or more model constraints from an external source;
conditionally updating, using the at least a processor, the regulatory data based on the temporal datum; and
modifying, using the at least a processor, the output as a function of the updated regulatory data.

15. The method of claim 11, further comprising receiving, using the at least a processor, a predefined data schema of the at least a data schema from a user interface.

16. The method of claim 11, further comprising modifying, using the at least a processor, the data schema by:
identifying one or more gap datums; and
determining, using an automated feedback loop, a remediation datum based on the one or more identified gap datums.

17. The method of claim 11, further comprising training, using the at least a processor, the AI-PII model on PII training data, wherein the PII training data comprises historical PII data mapped to historical data schemas.

18. The method of claim 11, further comprising training the AI-PII model using a reinforcement learning model, wherein the reinforcement learning model is configured to:
assign rewards based on a classification; and
update a mapping policy based on a cumulative reward and the classification.

19. The method of claim 11, further comprising categorizing, using the AI-PII model, the at least a PII datum to the one or more categories by:
identifying one or more key words of the PII data; and
classifying, using a classifier, the one or more key words based on a rules-based function.

20. The method of claim 11, further comprising transmitting, using the at least a processor, the output to one or more downstream models, wherein the one or more downstream models is configured to:
receive the output; and
execute a downstream command as a function of the output.
